(19) United States
(12) Patent Application Publication
(10) Pub. No.: US 2026/0037901 A1
(43) Pub. Date: Feb. 5, 2026

(54) LARGE LANGUAGE MODELS FOR ROBUST KPI CALCULATIONS

(71) Applicant: SAP SE, Walldorf (DE)

(72) Inventors: Vishesh P. Arora, Singapore (SG); Zhen Shu, Singapore (SG)

(21) Appl. No.: 18/791,040

(22) Filed: Jul. 31, 2024

(51) Int. Cl. G06Q 10/0639

(52) U.S. Cl. CPC G06Q 10/06393; G06Q 10/06395

(57) ABSTRACT

A robust KPI calculator is designed to handle complex financial data and calculate multiple KPIs at once, regardless of the naming conventions used by the business. The solution extracts key figures by interpreting semantic meaning to enable flexibility in naming conventions. The LLM KPI calculator may use one or more of a chain of thought extractor (CoTE), a KPI metrics parser (KMP), a financial data reader (FDR), and a ReAct implement calculator (RIC). The CoTE extracts shortlisted formulas and relevant names of key figures using chain-of-thought (CoT) prompting. The KMP parses the response from CoTE into structured data that includes the shortlisted KPI formulas and key figure names. The FDR reads relevant values of key figures from multiple financial sheets. The RIC applies the shortlisted formulas based on the relevant key figures and uses a calculator tool to compute the KPIs.

### TECHNICAL FIELD

The subject matter disclosed herein generally relates to determining key performance indicators (KPIs), and more specifically, to using large language models (LLMs) for robust KPI calculations.

### BACKGROUND

Businesses frequently need to analyze their financial statements to make informed decisions and predict future trends. KPIs provide critical insights into the company's overall health and its operational efficiency. However, not all KPIs are explicitly stated in these reports. Some need to be calculated using data scattered across various financial sheets. This process can be tedious if carried out manually. Automating the task is also challenging due to the differences in the naming conventions used by various businesses for their financial sheets. This lack of standardization makes it difficult to develop a one-size-fits-all automated solution for calculating KPIs.

LLMs process natural-language input to generate natural-language output. However, they are susceptible to “hallucinations,” generating responses that are not based in fact. Accordingly, in many applications, the output of LLMs cannot be trusted.

ReAct prompting asks an LLM to generate both reasoning traces and actions. The actions may allow the LLM to access external tools, such as search engines or calculators.

### BRIEF DESCRIPTION OF THE DRAWINGS

FIG. 1 shows a network diagram illustrating an example network environment suitable for using LLMs for robust KPI calculations.

FIG. 2 shows a block diagram of an application server, suitable for using an LLM for robust KPI calculations.

FIG. 3 is a block diagram of a neural network, suitable for use as a machine learning model for robust KPI calculations, according to some example embodiments.

FIG. 4 illustrates an example database schema for use by an LLM-based KPI calculation system.

FIG. 5 illustrates a data flow for an LLM-based KPI calculation system, according to some example embodiments.

FIG. 6 illustrates a data flow for an LLM-based KPI calculation system, according to some example embodiments.

FIG. 7 shows an illustration of a user interface suitable for an LLM-based KPI calculation system, according to some example embodiments.

FIG. 8 shows an illustration of a user interface suitable for an LLM-based KPI calculation system, according to some example embodiments.

FIG. 9 illustrates a method of providing an LLM-based KPI calculation system, according to some example embodiments.

FIG. 10 shows a block diagram showing one example of a software architecture for a computing device.

FIG. 11 shows a block diagram of a machine in the example form of a computer system within which instructions may be executed for causing the machine to perform any one or more of the methodologies discussed herein.

### DETAILED DESCRIPTION

Example methods and systems are directed to improving KPI calculations using an LLM-based KPI calculation systems. There are several issues that prevent LLMs from being used in practical settings. For example, LLMs require context like formula sheets and financial data to perform their operations correctly. However, providing this context consumes a significant number of tokens in the prompt, making the process inefficient. While ReAct prompting does allow LLMs to perform simple calculations on small spreadsheets, they tend to make mistakes when dealing with unclean, real-world financial statements that contain excessive information. This confuses the LLM and leads to errors such as hallucinating financial data and incorrectly using external tools. Moreover, the complexity of the prompts makes the LLM extremely brittle, and unable to calculate multiple KPIs simultaneously.

As discussed herein, a robust LLM KPI calculator is disclosed. The robust KPI calculator is designed to handle complex financial data and calculate multiple KPIs at once, regardless of the naming conventions used by the business. The solution dynamically reads metrics as needed, mitigating data overload to the LLM. It extracts key figures by interpreting semantic meaning to enable flexibility in naming conventions.

The LLM KPI calculator may use one or more of a chain of thought extractor (CoTE), a KPI metrics parser (KMP), a financial data reader (FDR), and a ReAct implemented calculator (RIC). The CoTE extracts shortlisted formulas and relevant names of key figures using chain-of-thought (CoT) prompting. The KMP parses the response from CoTE into structured data (e.g., a Pydantic base model) that includes the shortlisted KPI formulas and key figure names. The FDR reads relevant values of key figures from multiple financial sheets. The RIC applies the shortlisted formulas based on the relevant key figures and uses a calculator tool to compute the KPIs.

The CoTE is responsible for filtering out unnecessary information, such as non-essential formulas and irrelevant financial key figures. The CoT prompting technique is employed to enhance the ability of LLMs to tackle complex arithmetic and reasoning tasks. It breaks down a complicated task into a series of intermediate reasoning steps guiding LLMs towards a conclusive solution.

The FDR uses the parsed information from the KMP to obtain figures from the relevant data sources (e.g., database tables or spreadsheets). It saves all financial statements into a data structure (e.g., a Pandas DataFrame) and uses the key figures' names as an index to extract numerical values from the relevant data sources. The LLM operates without access to the contents of the data sources, therefore minimizing token usage in the process. The output of the FDR is a string to be passed into the next LLM chain as a prompt.

The RIC returns the user requested KPIs by computing the shortlisted formulas from the CoTE using the financial data from FDR. The ReAct technique may be applied to overcome the challenge posed by LLMs' limitations in mathematical calculations. The LLM is granted access to a calculator and ensures that numerical values undergo cleaning procedures before undergoing subsequent processing (e.g., removing currency symbols, commas in numbers, or both). By cleaning the values before providing them to a ReAct calculator, accuracy of the results generated by the calculator are improved.

By using the systems and methods herein, a computing system serving the purpose of a KPI calculator is improved. Traditional KPI calculating tools require a user to identify specific key figures from specific data sources to perform the calculation. The natural-language processing ability of LLMs allow more general instructions to be correctly processed. However, typical natural language processing using LLMs have a significant risk of hallucination and difficulty in performing correct calculations, both of which are addressed by the disclosed system, improving the value of search results. Accordingly, the disclosed systems improve over existing KPI calculation tools, whether those tools use or do not use LLMs.

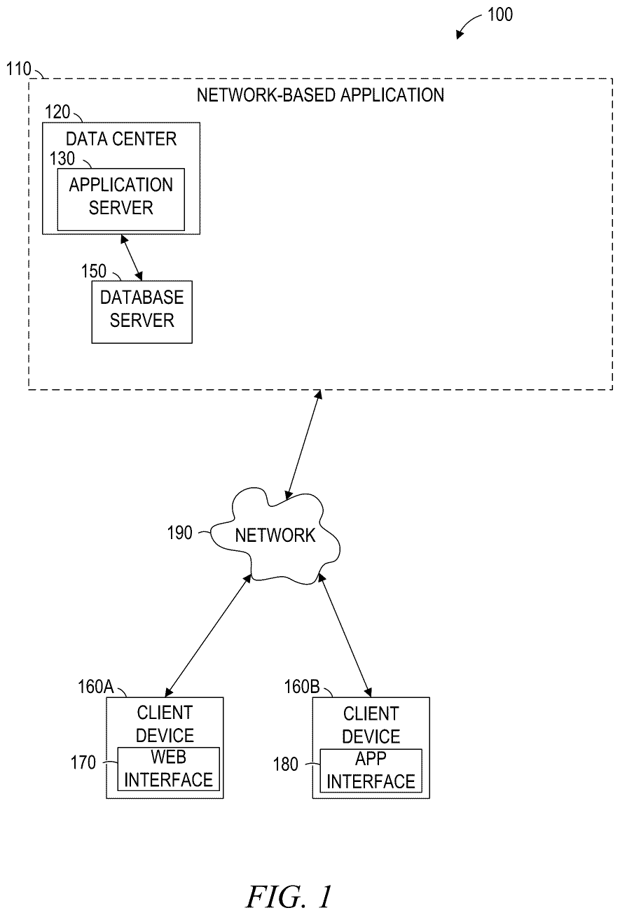

FIG. 1 shows a network diagram illustrating an example network environment 100 suitable for using LLMs for robust KPI calculations. The network environment 100 includes a network-based application 110, client devices 160A and 160B, and a network 190. The network-based application 110 is implemented at a data center 120 comprising an application server 130 in communication with a database server 150.

An application executing on the application server 130 may access data from the database server 150. The letter suffixes of reference numbers may be omitted when doing so does not raise ambiguity. For example, the client devices 160A-160B may be referred to collectively as “client devices 160.” Similarly, when the specific one of the client devices 160A-160B is not of particular import, “client device 160” may be referenced.

The application running on the application server 130 may provide services to the client devices 160A and 160B. For example, a user of the client device 160A may be an employee of a business using a business application. The user may use the services to generate invoices, manage employees, develop other applications, determine values for KPIs, or any suitable combination thereof. The user interface for the application may be presented using a web interface 170 or an app interface 180.

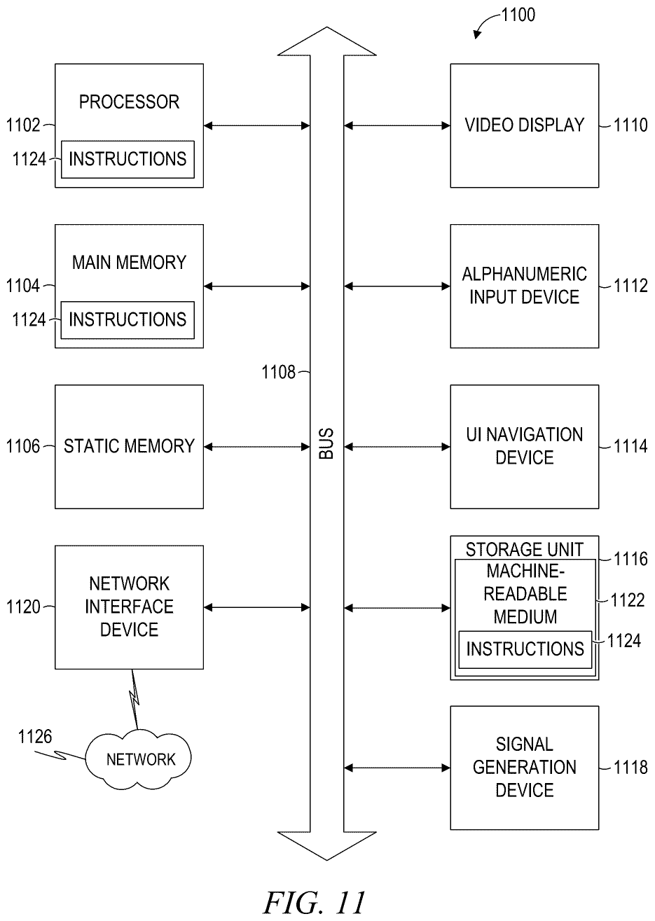

The application server 130, the database server 150, and the client devices 160A-160B may each be implemented in a computer system, in whole or in part, as described below with respect to FIG. 11. Any of the machines, databases, or devices shown in FIG. 1 may be implemented in a general-purpose computer modified (e.g., configured or programmed) by software to be a special-purpose computer to perform the functions described herein for that machine, database, or device. For example, a computer system able to implement any one or more of the methodologies described herein is discussed below with respect to FIG. 11. As used herein, a “database” is a data storage resource and may store data structured as a text file, a table, a spreadsheet, a relational database (e.g., an object-relational database), a triple store, a hierarchical data store, a document-oriented NoSQL database, a file store, or any suitable combination thereof. The database may be an in-memory database. Moreover, any two or more of the machines, databases, or devices illustrated in FIG. 1 may be combined into a single machine, database, or device, and the functions described herein for any single machine, database, or device may be subdivided among multiple machines, databases, or devices.

The application server 130, the database server 150, and the client devices 160A-160B are connected by the network 190. The network 190 may be any network that enables communication between or among machines, databases, and devices. Accordingly, the network 190 may be a wired network, a wireless network (e.g., a mobile or cellular network), or any suitable combination thereof. The network 190 may include one or more portions that constitute a private network, a public network (e.g., the Internet), or any suitable combination thereof.

Though FIG. 1 shows only one or two of each element (e.g., one application server 130, two client devices 160A and 160B, and the like), any number of each element is contemplated. For example, the application server 130 may be one of dozens or hundreds of active and standby servers and provide services to millions of client devices.

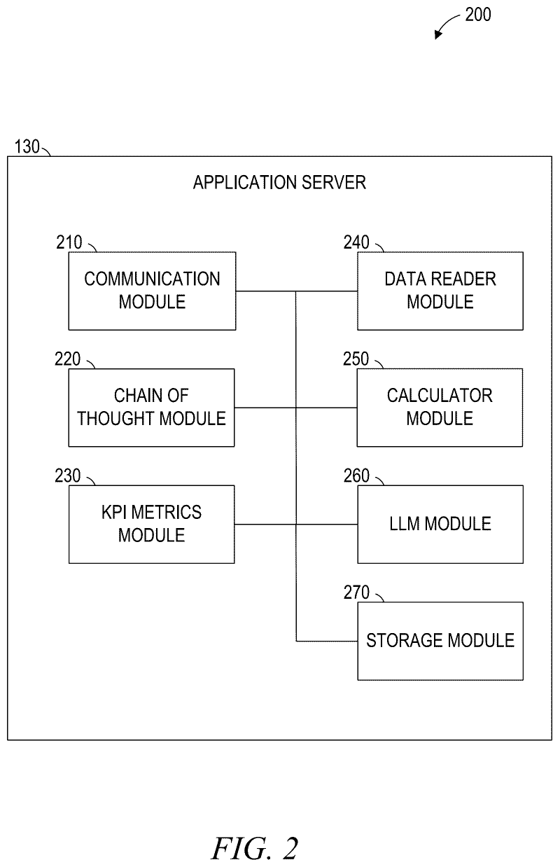

FIG. 2 shows a block diagram 200 of the application server 130, suitable for using an LLM for robust KPI calculations. The application server 130 is shown as including a communication module 210, a chain of thought module 220, a KPI metrics module 230, a data reader module 240, a calculator module 250, an LLM module 260, and a storage module 270, all configured to communicate with each other (e.g., via a bus, shared memory, or a switch). Any one or more of the modules described herein may be implemented using hardware (e.g., a processor of a machine). For example, any module described herein may be implemented by a processor configured to perform the operations described herein for that module. Moreover, any two or more of these modules may be combined into a single module, and the functions described herein for a single module may be subdivided among multiple modules. Furthermore, modules described herein as being implemented within a single machine, database, or device may be distributed across multiple machines, databases, or devices.

The communication module 210 receives data sent to the application server 130 and transmits data from the application server 130. For example, the communication module 210 may receive, from the client device 160A, a request for one or more KPIs. In response, the communication module 210 provides the user input to the chain of thought module 220. After operations involving one or more of the chain of thought module 220, the KPI metrics module 230, the data reader module 240, the calculator module 250, the LLM module 260, and the storage module 270, values for the KPIs are determined. The communication module 210 sends the determined KPIs to the requesting client device 160A for presentation to the user.

The chain of thought module 220 generates a prompt for an LLM. The prompt includes instructions, formulas for requested KPIs, names of key figures that are available from data sources, or any suitable combination thereof. The prompt is provided to the LLM module 260, which generates text output. The KPI metrics module 230 converts the text output from the LLM module 260 into a data structure for further processing.

The data structure from the KPI metrics module 230 identifies the key figures from the data sources that will be used to determine the requested KPIs. The data reader module 240 accesses values for the key figures identified by the data structure.

The calculator module 250 generates a second prompt for the LLM. The second prompt includes instructions, the formulas for the requested KPIs, the values for the key figures accessed by the data reader module 240, or any suitable combination thereof. The second prompt is provided to the LLM module 260, which generates a response that includes values of the KPIs. The LLM module 260 may make use of a ReAct implemented calculator to improve accuracy of computations.

Data, metadata, documents, instructions, or any suitable combination thereof may be stored and accessed by the storage module 270. For example, local storage of the application server 130, such as a hard drive, may be used. As another example, network storage may be accessed by the storage module 270 via the network 190.

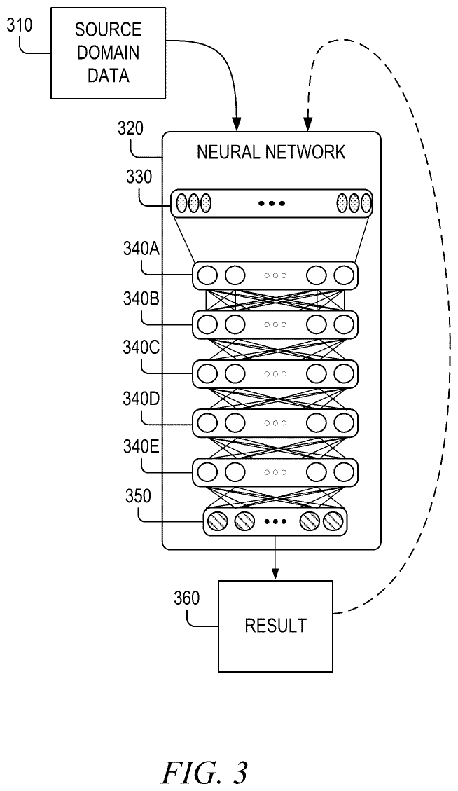

FIG. 3 is a block diagram of a neural network 320, suitable for use as a machine learning model for robust KPI calculations, according to some example embodiments. The neural network 320 takes source domain data 310 as input and processes the source domain data 310 using an input layer 330; intermediate, hidden layers 340A, 340B, 340C, 340D, and 340E; and output layer 350 to generate a result 360.

A neural network, sometimes referred to as an artificial neural network, is a computing system based on consideration of biological neural networks of animal brains. Such systems progressively improve performance, which is referred to as learning, to perform tasks, typically without task-specific programming. For example, in image recognition, a neural network may be taught to identify images that contain an object by analyzing example images that have been tagged with a name for the object and, having learned the object and name, may use the analytic results to identify the object in untagged images.

A neural network is based on a collection of connected units called neurons, where each connection, called a synapse, between neurons can transmit a unidirectional signal with an activating strength that varies with the strength of the connection. The receiving neuron can activate and propagate a signal to downstream neurons connected to it, typically based on whether the combined incoming signals, which are from potentially many transmitting neurons, are of sufficient strength, where strength is a parameter.

Each of the layers 330-350 comprises one or more nodes (or “neurons”). The nodes of the neural network 320 are shown as circles or ovals in FIG. 3. Each node takes one or more input values, processes the input values using zero or more internal variables, and generates one or more output values. The inputs to the input layer 330 are values from the source domain data 310. The output of the output layer 350 is the result 360. The intermediate layers 340A-340E are referred to as “hidden” because they do not interact directly with either the input or the output and are completely internal to the neural network 320. Though five hidden layers are shown in FIG. 3, more or fewer hidden layers may be used.

A model may be run against a training dataset for several epochs, in which the training dataset is repeatedly fed into the model to refine its results. In each epoch, the entire training dataset is used to train the model. Multiple epochs (e.g., iterations over the entire training dataset) may be used to train the model. In some example embodiments, the number of epochs is 10, 100, 500, or 1000. Within an epoch, one or more batches of the training dataset are used to train the model. Thus, the batch size ranges between one and the size of the training dataset, and the number of epochs is any positive integer value. The model parameters are updated after each batch (e.g., using gradient descent).

For self-supervised learning, the training dataset comprises self-labeled input examples. For example, a set of color images could be automatically converted to black-and-white images. Each color image may be used as a “label” for the corresponding black-and-white image and used to train a model that colorizes black-and-white images. This process is self-supervised because no additional information, outside of the original images, is used to generate the training dataset. Similarly, when text is provided by a user, one word in a sentence can be masked and the network trained to predict the masked word based on the remaining words.

Each model develops a rule or algorithm over several epochs by varying the values of one or more variables affecting the inputs to more closely map to a desired result, but as the training dataset may be varied, and is preferably very large, perfect accuracy and precision may not be achievable. A number of epochs that make up a learning phase, therefore, may be set as a given number of trials or a fixed time/computing budget, or may be terminated before that number/budget is reached when the accuracy of a given model is high enough or low enough or an accuracy plateau has been reached. For example, if the training phase is designed to run n epochs and produce a model with at least 95% accuracy, and such a model is produced before the nth epoch, the learning phase may end early and use the produced model, satisfying the end-goal accuracy threshold. Similarly, if a given model is inaccurate enough to satisfy a random chance threshold (e.g., the model is only 55% accurate in determining true/false outputs for given inputs), the learning phase for that model may be terminated early, although other models in the learning phase may continue training. Similarly, when a given model continues to provide similar accuracy or vacillate in its results across multiple epochs—having reached a performance plateau-the learning phase for the given model may terminate before the epoch number/computing budget is reached.

Once the learning phase is complete, the models are finalized. In some example embodiments, models that are finalized are evaluated against testing criteria. In a first example, a testing dataset that includes known outputs for its inputs is fed into the finalized models to determine an accuracy of the model in handling data that it has not been trained on. In a second example, a false positive rate or false negative rate may be used to evaluate the models after finalization. In a third example, a delineation between data clusters is used to select a model that produces the clearest bounds for its clusters of data.

The neural network 320 may be a deep learning neural network, a deep convolutional neural network (CNN), a recurrent neural network, a transformer neural network, or another type of neural network. A neuron is an architectural element used in data processing and artificial intelligence, particularly machine learning. A neuron implements a transfer function by which a number of inputs are used to generate an output. In some example embodiments, the inputs are weighted and summed, with the result compared to a threshold to determine if the neuron should generate an output signal (e.g., a 1) or not (e.g., a 0 output). The inputs of the component neurons are modified through the training of a neural network. One of skill in the art will appreciate that neurons and neural networks may be constructed programmatically (e.g., via software instructions) or via specialized hardware linking each neuron to form the neural network.

An example type of layer in the neural network 320 is a Long Short Term Memory (LSTM) layer. An LSTM layer includes several gates to handle input vectors (e.g., time-series data), a memory cell, and an output vector. The input gate and output gate control the information flowing into and out of the memory cell, respectively, whereas forget gates optionally remove information from the memory cell based on the inputs from linked cells earlier in the neural network. Weights and bias vectors for the various gates are adjusted over the course of a training phase, and once the training phase is complete, those weights and biases are finalized for normal operation.

A deep neural network (DNN) is a stacked neural network, which is composed of multiple layers. The layers are composed of nodes, which are locations where computation occurs, loosely patterned on a neuron in the human brain, which fires when it encounters sufficient stimuli. A node combines input from the data with a set of coefficients, or weights, that either amplify or dampen that input. Thus, the coefficients assign significance to inputs for the task the algorithm is trying to learn. these input-weight products are summed, and the sum is passed through what is called a node's activation function, to determine whether and to what extent that signal progresses further through the network to affect the ultimate outcome. A DNN uses a cascade of many layers of non-linear processing units for feature extraction and transformation. Each successive layer uses the output from the previous layer as input. Higher-level features are derived from lower-level features to form a hierarchical representation. The layers following the input layer may be convolution layers that produce feature maps that are filtering results of the inputs and are used by the next convolution layer.

In training of a DNN architecture, a regression, which is structured as a set of statistical processes for estimating the relationships among variables, can include a minimization of a cost function. The cost function may be implemented as a function to return a number representing how well the neural network performed in mapping training examples to correct output. In training, if the cost function value is not within a pre-determined range, based on the known training images, backpropagation is used, where backpropagation is a common method of training artificial neural networks that are used with an optimization method such as a stochastic gradient descent (SGD) method.

Use of backpropagation can include propagation and weight updates. When an input is presented to the neural network, it is propagated forward through the neural network, layer by layer, until it reaches the output layer. The output of the neural network is then compared to the desired output, using the cost function, and an error value is calculated for each of the nodes in the output layer. The error values are propagated backwards, starting from the output, until each node has an associated error value, which roughly represents its contribution to the original output. Backpropagation can use these error values to calculate the gradient of the cost function with respect to the weights in the neural network. The calculated gradient is fed to the selected optimization method to update the weights to attempt to minimize the cost function.

In some example embodiments, the structure of each layer is predefined. For example, a convolution layer may contain small convolution kernels and their respective convolution parameters, and a summation layer may calculate the sum, or the weighted sum, of two or more values. Training assists in defining the weight coefficients for the summation.

One way to improve the performance of DNNs is to identify newer structures for the feature-extraction layers, and another way is by improving the way the parameters are identified at the different layers for accomplishing a desired task. For a given neural network, there may be millions of parameters to be optimized. Trying to optimize all these parameters from scratch may take hours, days, or even weeks, depending on the amount of computing resources available and the amount of data in the training set.

One of ordinary skill in the art will be familiar with several machine learning algorithms that may be applied with the present disclosure, including linear regression, random forests, decision tree learning, neural networks, DNNs, genetic or evolutionary algorithms, and the like. With the help of natural language processing (NLP) and advanced data pre-processing, a machine learning model (e.g., the neural network 320) can be trained on historical (existing) data (for instance, resource usage data) from the system to predict future data.

The transformer architecture processes an entire input at once rather than sequentially. For example, a recurrent neural network (RNN) processes words or sentences sequentially, with the output of the RNN treated as an input for each input after the first (thus the use of the word “recurrent” in the name). As a result, relationships between elements that are far apart in the input are difficult to detect. The transformer architecture receives a larger input and learns the interrelationships between the elements and the output using an attention mechanism. Since all elements are processed together, distance between the elements of the input does not affect the learning process. The output may still be generated sequentially, with the previous result (e.g., word for an LLM, pixel for an image-generating artificial intelligence, and the like) being provided as an input for determination of the next result.

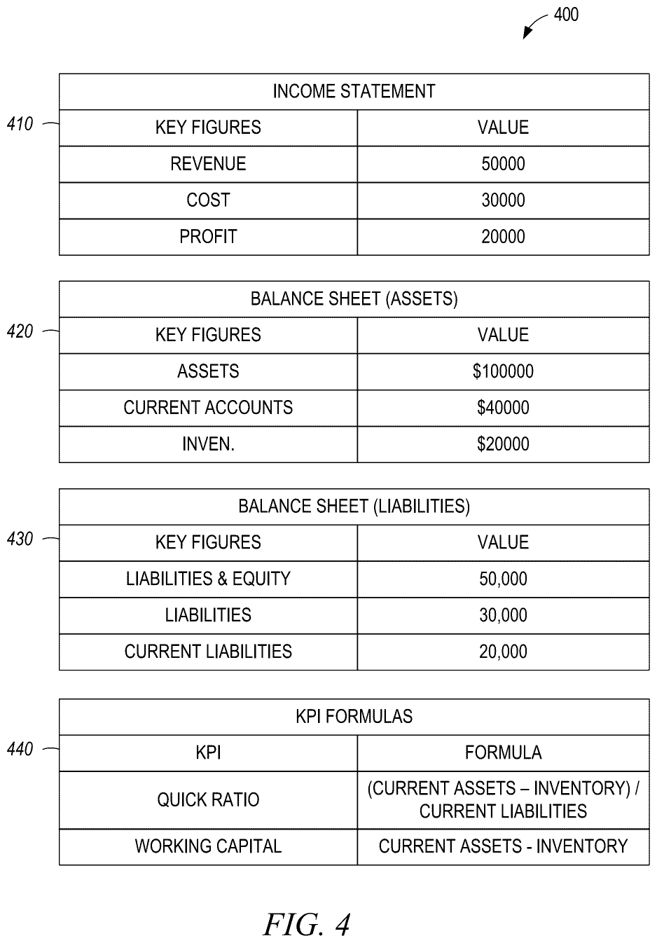

FIG. 4 illustrates an example database schema 400 for use by an LLM-based KPI calculation system. The database schema 400 includes table 410, 420, 430, and 440. The tables 410-430 are data sources. Each data source has a name, a set of key figures, and a value for each key figure. The table 440 stores KPI formulas. Each KPI has a name and a formula. Data from the data schema 400 may be used by the application server 130 to calculate KPIs.

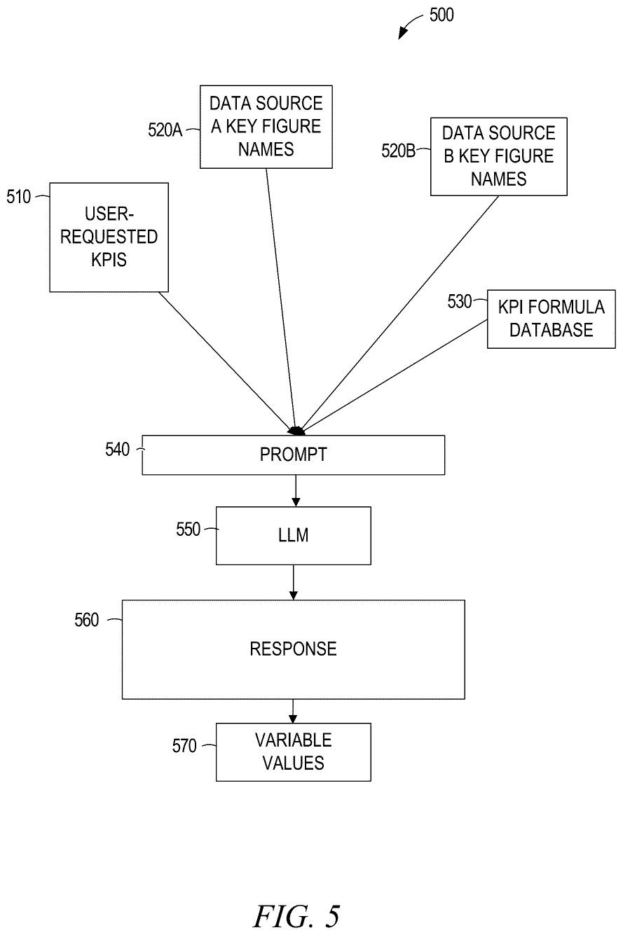

FIG. 5 illustrates a data flow 500 for an LLM-based KPI calculation system, according to some example embodiments. User-requested KPIs 510, data source A key figure names 520A, data source B key figure names 520B, KPI formula database 530, or any suitable combination thereof, are used to generate a prompt 540. The prompt 540 is provided to an LLM 550. In response to the prompt 540, the LLM 550 generates a mapping of data source/key figure pairs for variables in KPI formulas for the user-requested KPIs, provided in the response 560. Data of the identified key figures of the identified data sources is accessed to create variable values 570.

The user-requested KPIs 510 may be received via a user interface. The key figure names 520A-520B may be accessed from the tables 410-430 of FIG. 4. The KPI formula database 530 may be accessed from the table 440 of FIG. 4. An example of the prompt 540 is:
You will be provided with a “formula sheet”, a list of “key figures,” and some “user kpis”. Perform the steps within the following triple backticks
1. List out the formulas for all user kpis.
2. List out the variables (on the right-hand side of the equation) from the formula sheet.
3. For every variable you listed, find ONE variable from “key figures” that is the most semantically similar, if not identical, to the variable. Then, identify the “data source” it originates from.
Here is the formula sheet
{“Quick Ratio=(Current Assets−Inventory)/Current Liabilities”, “Working Capital=Current Assets−Inventory”}
Here are the user kpis
Quick Ratio
Here are the key_figures
{“Income Statement: Revenue, Cost, Profit”, “Balance Sheet (Assets): Assets, Current Accounts, Inven.”, “Balance Sheet (Liabilities): “Liabilities & Equity, Liabilities, Current Liabilities”}
Begin your task!

In accordance with the example prompt above, the LLM may determine the data source and key figure pairs for the variable names based on semantic similarity. For example, the Current Liabilities key figure in the Liabilities & Equity data source is an exact match for the Current Liabilities variable name, and so may be selected as the most semantically similar. Semantic similarity depends on meaning, so the most likely key figures may be selected even when no exact match exists. Thus, the Current Accounts key figure from the Balance Sheet (Assets) data source may be selected as the best semantic match for the “Current Assets” variable name based on the identity of “current” and the similarity between “assets” and “accounts.”

An example response from the LLM 550 is:
1. Listing out the formulas for user requested KPIs.
   Quick Ratio=(Current Assets−Inventory)/Current Liabilities
2. Listing out the variables (on the right-hand side of the equation) from the formula sheet.
   Current Assets
   Inventory
   Current Liabilities
3. For every variable you listed, find ONE variable from “key figures” that is the most semantically similar, if not identical, to the variable. Then, identify the “data source” it originates from.
   Current Assets: ‘Current Accounts’ from Balance Sheet (Assets)
   Current Liabilities: ‘Current Liabilities’ from Balance Sheet (Liabilities)
   Inventory: ‘Inven.’ from Balance Sheet (Assets)

The data reader module 240 may use a langchain Pydantic output parser to convert the text output of the response 560 into a data structure for further processing. The data structure may be processed to generate variable values 570. For example, data from the database tables 420 and 430 of FIG. 4 may be accessed to generate the variable values 570, as shown below:
The value of Current Assets is 40000.
The value of Current Liabilities is 20000.
The value of Inventory is 20000.

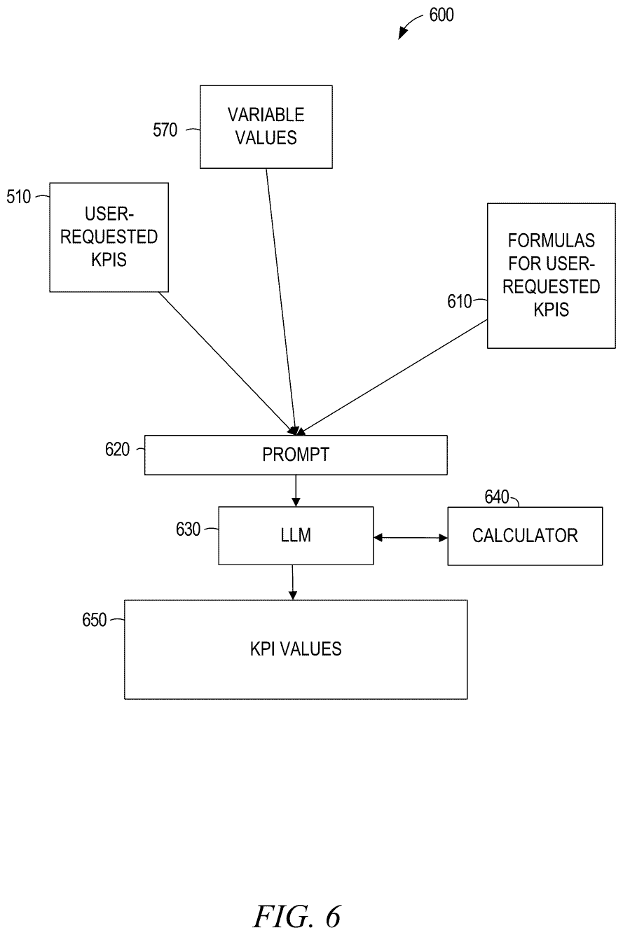

FIG. 6 illustrates a data flow 600 for an LLM-based KPI calculation system, according to some example embodiments. The data flow 600 may be used after the data flow 500, which generates the variable values 570 and the formulas for user-requested KPIs 610.

The user-requested KPIs 510, the variable values 570, the formulas for user-requested KPIs 610, or any suitable combination thereof, are used to generate a prompt 620. The prompt 620 is provided to an LLM 630. An example of the prompt 620 is:
Calculate the following KPIs using their given formulas. The formula sheet is as follows:
Quick Ratio=(Current Assets−Inventory)/Current Liabilities
Here are the values for the variables:
The value of Current Assets is 40000.
The value of Current Liabilities is 20000.
The value of Inventory is 20000.
Give your answer to two decimal places.

In response to the prompt 620, the LLM 630 generates KPI values 650 for the user-requested KPIs 510. The LLM 630 may make use of a calculator tool 640 to determine the KPI values 650. ReAct agents provide tools to LLMs by implementing functions with semantic descriptions. When the LLM determines that an answer is helped by the described tool, the LLM invokes the function and uses the result. For example, a multiply function may be described as “Multiply two numbers and return the result number,” with a function declaration of “multiply (a: number, b: number)->number.” When the LLM decides to multiply two numbers, it invokes the multiply function. Thus, the values for the set of variables may be provided to a calculator tool and intermediate values or the KPI values received from the calculator tool.

An example of the KPI values 650 is:
The Quick Ratio is 1.00

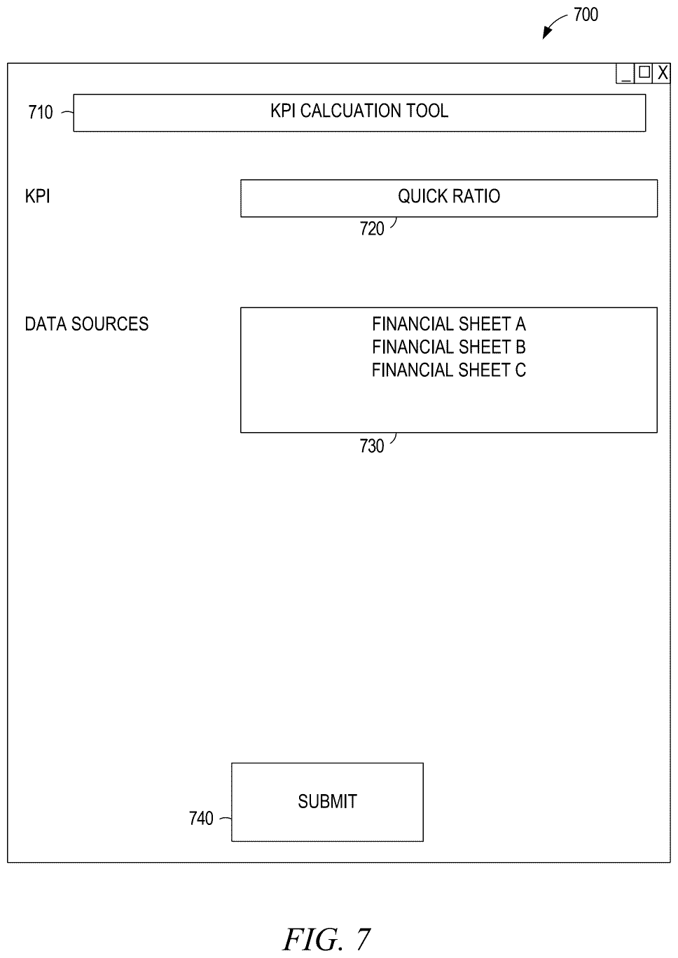

FIG. 7 shows an illustration of a user interface 700 suitable for an LLM-based KPI calculation system, according to some example embodiments. The user interface 700 includes a title 710, input fields 720 and 730, and a button 740. The user interface 700 may be generated by the application server 130 and presented on a display of one of the client devices 160 (all of FIG. 1).

The title 710 indicates that the user interface 700 is for a KPI calculation tool. The input field 720 is operable by a user to select one or more KPIs to be calculated. The input field 720 may be a drop-down selector, a checkbox selector, a text field, or any suitable combination thereof. The input field 730 is operable by a user to select one or more data sources to be accessed in calculating the selected KPIs. The input field 730 may be a drop-down selector, a checkbox selector, a text field, or any suitable combination thereof.

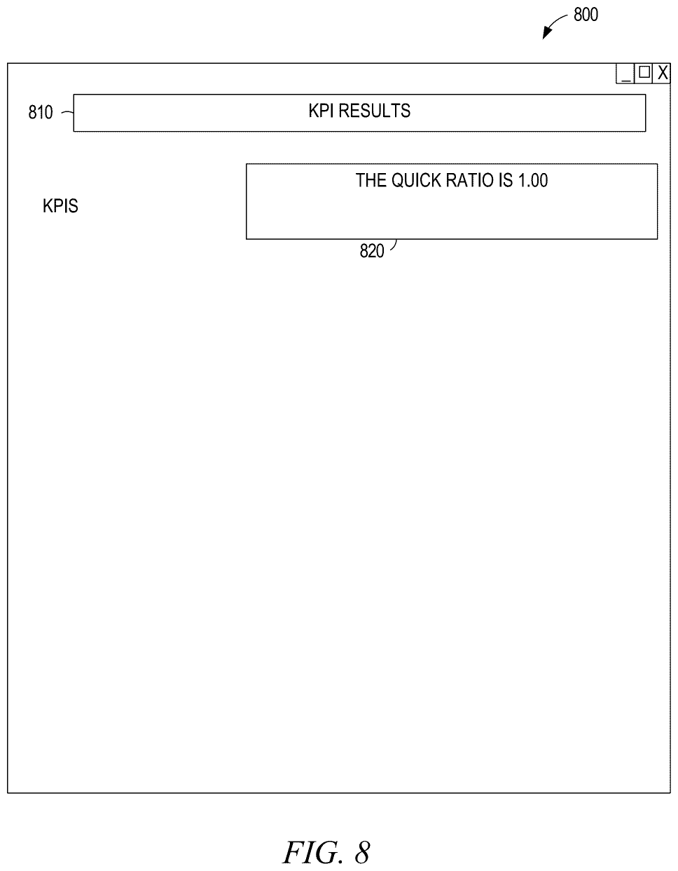

The input fields 720 and 730 may be submitted to the application server 130 via operation of the button 740. For example, clicking or touching the button 740 may result in a request being sent from the client device 160A to the application server 130, the request being for a Quick Ratio KPI determined from data in Financial Sheets A, B, and C. In response to the request, the application server 130 may determine the requested KPI and cause the KPI to be presented to the user (e.g., using the user interface 800 of FIG. 8, discussed below).

FIG. 8 shows an illustration of a user interface 800 suitable for an LLM-based KPI calculation system, according to some example embodiments. The user interface 800 includes a title 810 and an output field 820. The user interface 800 may be generated by the application server 130 and presented on a display of one of the client devices 160 (all of FIG. 1) after submission of a KPI request via the user interface 700 of FIG. 7.

The title 810 indicates that the user interface 800 is for presentation of KPI results. The output field 820 shows the KPI results. In the example of FIG. 7, the KPI request is for a Quick Ratio. Accordingly, in the example of FIG. 8, the output field 820 shows the determined Quick Ratio value.

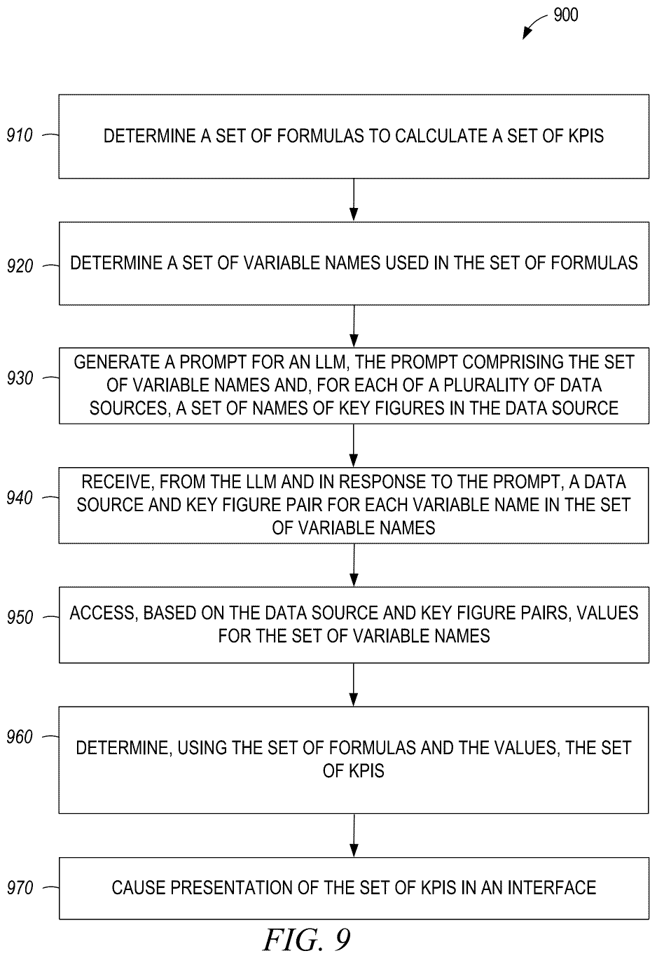

FIG. 9 illustrates a method 900 of providing an LLM-based KPI calculation system, according to some example embodiments. The method 900 includes operations 910, 920, 930, 940, 950, 960, and 970. By way of example and not limitation, the method 900 is described as being performed by the application server 130 of FIG. 1, using the modules of FIG. 2, the machine learning model of FIG. 3, the data sources of FIG. 4, the data flows of FIGS. 5-6, and the user interfaces of FIGS. 7-8.

In operation 910, the chain of thought module 220 determines a set of formulas to calculate a set of KPIs. For example, the set of KPIs may be received from the client device 160A via the user interface 700 of FIG. 7. Thus, the method 900 may further comprise receiving a user request for the set of KPIs. The set of formulas to calculate the set of KPIs may be determined by accessing a KPI formula database, such as the table 440 of FIG. 4, containing KPI formulas. For example, if the KPI is Quick Ratio, the KPI formula is Quick Ratio=(Current Assets−Inventory)/Current Liabilities.

The chain of thought module 220, in operation 920, determines a set of variable names used in the set of formulas. In this example, the variable names are Current Assets, Inventory, and Current Liabilities.

In operation 930, the chain of thought module 220 generates a prompt for an LLM, the prompt comprising the set of variable names and, for each of a plurality of data sources, a set of names of key figures in the data source. For example, the prompt 540, discussed above with respect to FIG. 5, may be generated.

The KPI metrics module 230, in operation 940, receives, from the LLM and in response to the prompt, a data source and key figure pair for each variable name in the set of variable names. For example, the response may include:
Current Assets: ‘Current Accounts’ from Balance Sheet (Assets)
Current Liabilities: ‘Current Liabilities’ from Balance Sheet (Liabilities)
Inventory: ‘Inven.’ from Balance Sheet (Assets)

In this response, “Current Accounts”, “Current Liabilities”, and “Inven.” are key figures and “Balance Sheet (Assets)” and “Balance Sheet (Liabilities)” are data sources. Thus, for each key figure (“Current Assets”, “Current Liabilities”, and “Inventory”), a data source and key figure pair is identified. The data source and key figure pair uniquely identify a value from among values available from the data sources.

In operation 950, the data reader module 240 accesses, based on the data source and key figure pairs, values for the set of variable names. In this example, the value for the variable named “Current Assets” is read from the data source “Balance Sheet (Assets),” table 420 of FIG. 4. The value of the key figure “Current Accounts” is read from the data source. As can be seen in FIG. 4, that value is “$40000.” The read value may be processed to remove non-numeric characters or provide other filtering. For example, the dollar sign may be removed, resulting in the value “40000.” Applying the same process to the other two variable names, a value of 20000 is found for “Current Liabilities” from the table 430 and a value of 20000 is found for “Inventory” from the table 420.

The KPI metrics module 230, in operation 960, determines, using the set of formulas and the values, the set of KPIs. For example, the prompt 620 of FIG. 6, discussed above, may be generated and provided to the LLM 630 to receive KPI values 650. Thus, the method 900 may include generating a second prompt for the LLM, the second prompt comprising the set of formulas and the values for the set of variables. In response to the second prompt, the LLM generates a response comprising the set of KPIs. Accordingly, the method 900 may include receiving, from the LLM and in response to the second prompt, the set of KPIs. In processing the second prompt, the LLM module 260 may make use of the calculator module 250.

The communication module 210 causes presentation of the set of KPIs in an interface (operation 970). In some example embodiments, the user interface 800 of FIG. 8 is used to present the set of KPIs.

By use of the method 900, a set of KPIs is calculated and presented by using an LLM. By comparison with methods that do not use an LLM, the method 900 is able to find values for variable names even when the variable names are not the same as the names of the key figures that store the values. By comparison with methods that use an LLM, the method 900 has improved accuracy and reduced hallucinations by virtue of the specific series of prompts provided, the use of the calculator module 250, or both. Accordingly, the method 900 represents an improvement in KPI-calculation technology.

In view of the above-described implementations of subject matter this application discloses the following list of examples, wherein one feature of an example in isolation or more than one feature of an example, taken in combination and, optionally, in combination with one or more features of one or more further examples are further examples also falling within the disclosure of this application.

Example 1 is a system comprising: a memory that stores instructions; and one or more processors coupled to the memory and configured to execute the instructions to perform operations comprising: determining a set of formulas to calculate a set of key performance indicators (KPIs); determining a set of variables used in the set of formulas, the set of variables having a corresponding set of variable names; generating a prompt for a large language model (LLM), the prompt comprising the set of variable names and, for each of a plurality of data sources, a set of names of key figures in the data source; receiving, from the LLM and in response to the prompt, a data source and key figure pair for each variable name in the set of variable names; accessing, based on the data source and key figure pairs, values for the set of variables; determining, using the set of formulas and the values for the set of variables, the set of KPIs; and causing presentation of the set of KPIs in an interface.

In Example 2, the subject matter of Example 1 includes, wherein the operations further comprise receiving a user request for the set of KPIs.

In Example 3, the subject matter of Examples 1-2, wherein the determining of the set of formulas comprises accessing a KPI formula database.

In Example 4, the subject matter of Examples 1-3, wherein the determining of the set of KPIs comprises: generating a second prompt for the LLM, the second prompt comprising the set of formulas and the values for the set of variables; and receiving, from the LLM and in response to the second prompt, the set of KPIs.

In Example 5, the subject matter of Examples 1-4, wherein the LLM removes a non-numeric character from a value.

In Example 6, the subject matter of Example 5, wherein the LLM determines a KPI by providing the value to a calculator tool and reading an output from the calculator tool.

In Example 7, the subject matter of Examples 1-6, wherein the LLM determines the data source and key figure pair for a variable name based on semantic similarity.

Example 8 is a non-transitory computer-readable medium that stores instructions that, when executed by one or more processors, cause the one or more processors to perform operations comprising: determining a set of formulas to calculate a set of key performance indicators (KPIs); determining a set of variables used in the set of formulas, the set of variables having a corresponding set of variable names; generating a prompt for a large language model (LLM), the prompt comprising the set of variable names and, for each of a plurality of data sources, a set of names of key figures in the data source; receiving, from the LLM and in response to the prompt, a data source and key figure pair for each variable name in the set of variable names; accessing, based on the data source and key figure pairs, values for the set of variables; determining, using the set of formulas and the values for the set of variables, the set of KPIs; and causing presentation of the set of KPIs in an interface.

In Example 9, the subject matter of Example 8, wherein the operations further comprise receiving a user request for the set of KPIs.

In Example 10, the subject matter of Examples 8-9, wherein the determining of the set of formulas comprises accessing a KPI formula database.

In Example 11, the subject matter of Examples 8-10, wherein the determining of the set of KPIs comprises: generating a second prompt for the LLM, the second prompt comprising the set of formulas and the values for the set of variables; and receiving, from the LLM and in response to the second prompt, the set of KPIs.

In Example 12, the subject matter of Examples 8-11, wherein the LLM removes a non-numeric character from a value.

In Example 13, the subject matter of Example 12, wherein the LLM determines a KPI by providing the value to a calculator tool and reading an output from the calculator tool.

In Example 14, the subject matter of Examples 8-13, wherein the LLM determines the data source and key figure pair for a variable name based on semantic similarity.

Example 15 is a method comprising: determining, by one or more processors, a set of formulas to calculate a set of key performance indicators (KPIs); determining a set of variables used in the set of formulas, the set of variables having a corresponding set of variable names; generating a prompt for a large language model (LLM), the prompt comprising the set of variable names and, for each of a plurality of data sources, a set of names of key figures in the data source; receiving, from the LLM and in response to the prompt, a data source and key figure pair for each variable name in the set of variable names; accessing, based on the data source and key figure pairs, values for the set of variables; determining, using the set of formulas and the values for the set of variables, the set of KPIs; and causing presentation of the set of KPIs in an interface.

In Example 16, the subject matter of Example 15 includes receiving a user request for the set of KPIs.

In Example 17, the subject matter of Examples 15-16, wherein the determining of the set of formulas comprises accessing a KPI formula database.

In Example 18, the subject matter of Examples 15-17, wherein the determining of the set of KPIs comprises: generating a second prompt for the LLM, the second prompt comprising the set of formulas and the values for the set of variables; and receiving, from the LLM and in response to the second prompt, the set of KPIs.

In Example 19, the subject matter of Examples 15-18, wherein the LLM removes a non-numeric character from a value.

In Example 20, the subject matter of Example 19, wherein the LLM determines a KPI by providing the value to a calculator tool and reading an output from the calculator tool.

Example 21 is an apparatus comprising means to implement any of Examples 1-20.

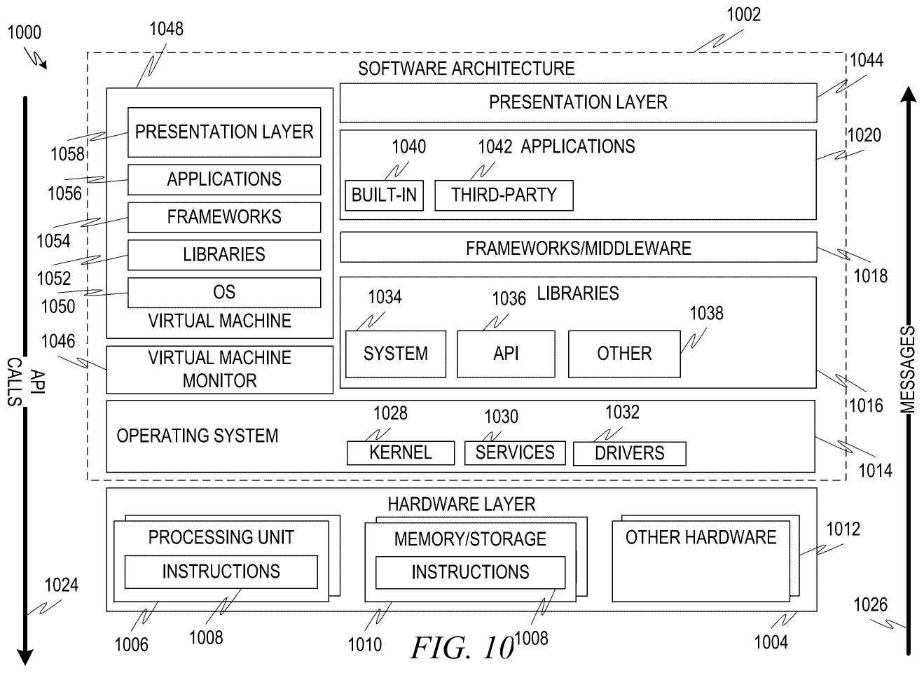

FIG. 10 shows a block diagram 1000 showing one example of a software architecture 1002 for a computing device. The software architecture 1002 may be used in conjunction with various hardware architectures, for example, as described herein. FIG. 10 is merely a non-limiting example of a software architecture, and many other architectures may be implemented to facilitate the functionality described herein. A representative hardware layer 1004 is illustrated and can represent, for example, any of the above referenced computing devices. In some examples, the hardware layer 1004 may be implemented according to the architecture of the computer system of FIG. 10.

The representative hardware layer 1004 comprises one or more processing units 1006 having associated executable instructions 1008. Executable instructions 1008 represent the executable instructions of the software architecture 1002, including implementation of the methods, modules, subsystems, and components, and so forth described herein and may also include memory and/or storage modules 1010, which also have executable instructions 1008. Hardware layer 1004 may also comprise other hardware as indicated by other hardware 1012 which represents any other hardware of the hardware layer 1004, such as the other hardware illustrated as part of the software architecture 1002.

In the example architecture of FIG. 10, the software architecture 1002 may be conceptualized as a stack of layers where each layer provides particular functionality. For example, the software architecture 1002 may include layers such as an operating system 1014, libraries 1016, frameworks/middleware 1018, applications 1020, and presentation layer 1044. Operationally, the applications 1020 and/or other components within the layers may invoke application programming interface (API) calls 1024 through the software stack and access a response, returned values, and so forth illustrated as messages 1026 in response to the API calls 1024. The layers illustrated are representative in nature and not all software architectures have all layers. For example, some mobile or special purpose operating systems may not provide a frameworks/middleware 1018 layer, while others may provide such a layer. Other software architectures may include additional or different layers.

The operating system 1014 may manage hardware resources and provide common services. The operating system 1014 may include, for example, a kernel 1028, services 1030, and drivers 1032. The kernel 1028 may act as an abstraction layer between the hardware and the other software layers. For example, the kernel 1028 may be responsible for memory management, processor management (e.g., scheduling), component management, networking, security settings, and so on. The services 1030 may provide other common services for the other software layers. In some examples, the services 1030 include an interrupt service. The interrupt service may detect the receipt of an interrupt and, in response, cause the software architecture 1002 to pause its current processing and execute an interrupt service routine (ISR) when an interrupt is accessed.

The drivers 1032 may be responsible for controlling or interfacing with the underlying hardware. For instance, the drivers 1032 may include display drivers, camera drivers, Bluetooth® drivers, flash memory drivers, serial communication drivers (e.g., Universal Serial Bus (USB) drivers), Wi-Fi® drivers, NFC drivers, audio drivers, power management drivers, and so forth depending on the hardware configuration.

The libraries 1016 may provide a common infrastructure that may be utilized by the applications 1020 and/or other components and/or layers. The libraries 1016 typically provide functionality that allows other software modules to perform tasks in an easier fashion than to interface directly with the underlying operating system 1014 functionality (e.g., kernel 1028, services 1030 and/or drivers 1032). The libraries 1016 may include system libraries 1034 (e.g., C standard library) that may provide functions such as memory allocation functions, string manipulation functions, mathematic functions, and the like. In addition, the libraries 1016 may include API libraries 1036 such as media libraries (e.g., libraries to support presentation and manipulation of various media format such as MPEG4, H.264, MP3, AAC, AMR, JPG, PNG), graphics libraries (e.g., an OpenGL framework that may be used to render two-dimensional and three-dimensional in a graphic content on a display), database libraries (e.g., SQLite that may provide various relational database functions), web libraries (e.g., WebKit that may provide web browsing functionality), and the like. The libraries 1016 may also include a wide variety of other libraries 1038 to provide many other APIs to the applications 1020 and other software components/modules.

The frameworks/middleware 1018 may provide a higher-level common infrastructure that may be utilized by the applications 1020 and/or other software components/modules. For example, the frameworks/middleware 1018 may provide various graphic user interface (GUI) functions, high-level resource management, high-level location services, and so forth. The frameworks/middleware 1018 may provide a broad spectrum of other APIs that may be utilized by the applications 1020 and/or other software components/modules, some of which may be specific to a particular operating system or platform.

The applications 1020 include built-in applications 1040 and/or third-party applications 1042. Examples of representative built-in applications 1040 may include, but are not limited to, a contacts application, a browser application, a book reader application, a location application, a media application, a messaging application, and/or a game application. Third-party applications 1042 may include any of the built-in applications as well as a broad assortment of other applications. In a specific example, the third-party application 1042 (e.g., an application developed using the Android™ or iOS™ software development kit (SDK) by an entity other than the vendor of the particular platform) may be mobile software running on a mobile operating system such as iOS™, Android™, Windows® Phone, or other mobile computing device operating systems. In this example, the third-party application 1042 may invoke the API calls 1024 provided by the mobile operating system such as operating system 1014 to facilitate functionality described herein.

The applications 1020 may utilize built-in operating system functions (e.g., kernel 1028, services 1030 and/or drivers 1032), libraries (e.g., system libraries 1034, API libraries 1036, and other libraries 1038), and frameworks/middleware 1018 to create user interfaces to interact with users of the system. Alternatively, or additionally, in some systems, interactions with a user may occur through a presentation layer, such as presentation layer 1044. In these systems, the application/module “logic” can be separated from the aspects of the application/module that interact with a user.

Some software architectures utilize virtual machines. In the example of FIG. 10, this is illustrated by virtual machine 1048. A virtual machine creates a software environment where applications/modules can execute as if they were executing on a hardware computing device. A virtual machine is hosted by a host operating system (operating system 1014) and typically, although not always, has a virtual machine monitor 1046, which manages the operation of the virtual machine 1048 as well as the interface with the host operating system (i.e., operating system 1014). A software architecture executes within the virtual machine 1048 such as an operating system 1050, libraries 1052, frameworks/middleware 1054, applications 1056 and/or presentation layer 1058. These layers of software architecture executing within the virtual machine 1048 can be the same as corresponding layers previously described or may be different.

### Modules, Components and Logic

A computer system may include logic, components, modules, mechanisms, or any suitable combination thereof. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. One or more computer systems (e.g., a standalone, client, or server computer system) or one or more hardware processors may be configured by software (e.g., an application or application portion) as a hardware-implemented module that operates to perform certain operations as described herein.

A hardware-implemented module may be implemented mechanically or electronically. For example, a hardware-implemented module may comprise dedicated circuitry or logic that is permanently configured (e.g., as a special-purpose processor, such as a field programmable gate array [FPGA] or an application-specific integrated circuit [ASIC]) to perform certain operations. A hardware-implemented module may also comprise programmable logic or circuitry (e.g., as encompassed within a general-purpose processor or another programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired), or temporarily or transitorily configured (e.g., programmed) to operate in a certain manner and/or to perform certain operations described herein. Hardware-implemented modules may be temporarily configured (e.g., programmed), and each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiples of such hardware-implemented modules exist contemporaneously, communications may be achieved through signal transmission (e.g., over appropriate circuits and buses that connect the hardware-implemented modules). Multiple hardware-implemented modules are configured or instantiated at different times. Communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. The processor or processors may be located in a single location (e.g., within a home environment, an office environment, or a server farm), or the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., APIs).

### Electronic Apparatus and System

The systems and methods described herein may be implemented using digital electronic circuitry, computer hardware, firmware, software, a computer program product (e.g., a computer program tangibly embodied in an information carrier, e.g., in a machine-readable medium for execution by, or to control the operation of, data processing apparatus, e.g., a programmable processor, a computer, or multiple computers), or any suitable combination thereof.

A computer program can be written in any form of programming language, including compiled or interpreted languages, and it can be deployed in any form, including as a standalone program or as a module, subroutine, or other unit suitable for use in a computing environment. A computer program can be deployed to be executed on one computer or on multiple computers at one site or distributed across multiple sites (e.g., cloud computing) and interconnected by a communication network. In cloud computing, the server-side functionality may be distributed across multiple computers connected by a network. Load balancers are used to distribute work between the multiple computers. Thus, a cloud computing environment performing a method is a system comprising the multiple processors of the multiple computers tasked with performing the operations of the method.

Operations may be performed by one or more programmable processors executing a computer program to perform functions by operating on input data and generating output. Method operations can also be performed by, and apparatus of systems may be implemented as, special purpose logic circuitry, e.g., an FPGA or an ASIC.

The computing system can include clients and servers. A client and server are generally remote from each other and typically interact through a communication network. The relationship of client and server arises by virtue of computer programs running on the respective computers and having a client-server relationship to each other. A programmable computing system may be deployed using hardware architecture, software architecture, or both. Specifically, it will be appreciated that the choice of whether to implement certain functionality in permanently configured hardware (e.g., an ASIC), in temporarily configured hardware (e.g., a combination of software and a programmable processor), or in a combination of permanently and temporarily configured hardware may be a design choice. Below are set out example hardware (e.g., machine) and software architectures that may be deployed.

### Example Machine Architecture and Machine-Readable Medium

FIG. 11 shows a block diagram of a machine in the example form of a computer system 1100 within which instructions 1124 may be executed for causing the machine to perform any one or more of the methodologies discussed herein. The machine may operate as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch, or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1100 includes a processor 1102 (e.g., a central processing unit (CPU), a graphics processing unit (GPU), or both), a main memory 1104, and a static memory 1106, which communicate with each other via a bus 1108. The computer system 1100 may further include a video display unit 1110 (e.g., a liquid crystal display (LCD) or a cathode ray tube (CRT)). The computer system 1100 also includes an alphanumeric input device 1112 (e.g., a keyboard or a touch-sensitive display screen), a user interface (UI) navigation (or cursor control) device 1114 (e.g., a mouse), a storage unit 1116, a signal generation device 1118 (e.g., a speaker), and a network interface device 1120.

### Machine-Readable Medium

The storage unit 1116 includes a machine-readable medium 1122 on which is stored one or more sets of data structures and instructions 1124 (e.g., software) embodying or utilized by any one or more of the methodologies or functions described herein. The instructions 1124 may also reside, completely or at least partially, within the main memory 1104 and/or within the processor 1102 during execution thereof by the computer system 1100, with the main memory 1104 and the processor 1102 also constituting a machine-readable medium 1122.

While the machine-readable medium 1122 is shown in FIG. 11 to be a single medium, the term “machine-readable medium” may include a single medium or multiple media (e.g., a centralized or distributed database, and/or associated caches and servers) that store the one or more instructions 1124 or data structures. The term “machine-readable medium” shall also be taken to include any tangible medium that is capable of storing, encoding, or carrying instructions 1124 for execution by the machine and that cause the machine to perform any one or more of the methodologies of the present disclosure, or that is capable of storing, encoding, or carrying data structures utilized by or associated with the instructions 1124. The term “machine-readable medium” shall accordingly be taken to include, but not be limited to, solid-state memories, and optical and magnetic media. Specific examples of machine-readable media include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and compact disc read-only memory (CD-ROM) and digital versatile disc read-only memory (DVD-ROM) disks. A machine-readable medium is not a transmission medium.

### Transmission Medium

The instructions 1124 may further be transmitted or received over a communications network 1126 using a transmission medium. The instructions 1124 may be transmitted using the network interface device 1120 and any one of a number of well-known transfer protocols (e.g., hypertext transport protocol [HTTP]). Examples of communication networks include a local area network (LAN), a wide area network (WAN), the Internet, mobile telephone networks, plain old telephone (POTS) networks, and wireless data networks (e.g., WiFi and WiMax networks). The term “transmission medium” shall be taken to include any intangible medium that is capable of storing, encoding, or carrying instructions 1124 for execution by the machine, and includes digital or analog communications signals or other intangible media to facilitate communication of such software.

Although specific examples are described herein, it will be evident that various modifications and changes may be made to these examples without departing from the broader spirit and scope of the disclosure. Accordingly, the specification and drawings are to be regarded in an illustrative rather than a restrictive sense. The accompanying drawings that form a part hereof show by way of illustration, and not of limitation, specific examples in which the subject matter may be practiced. The examples illustrated are described in sufficient detail to enable those skilled in the art to practice the teachings disclosed herein.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” and “an” are herein used, as is common in patent documents, to include one or more than one instance. Finally, as used herein, the conjunction “or” refers to a non-exclusive “or,” unless specifically stated otherwise.

1. A system comprising:
a memory that stores instructions; and
one or more processors coupled to the memory and configured to execute the instructions to perform operations comprising:
determining a set of formulas to calculate a set of key performance indicators (KPIs), each formula of the set of formulas comprising a set of variables used in the formula and a mathematical relationship between the set of variables and a corresponding KPI;
generating a first prompt for a large language model (LLM), the first prompt comprising names for the variables used in the set of formulas and, for each of a plurality of data sources, a set of names of key figures in the data source;
receiving, from the LLM and in response to the first prompt, a data source and key figure pair for each variable name in the set of variable names;
accessing, as a value for each of the variables used in the set of formulas, the key figure identified by the LLM from the data source identified by the LLM;
generating a second prompt for the LLM, the second prompt comprising the set of formulas and the values for the variables used in the set of formulas;
receiving, from the LLM and in response to the second prompt, the set of KPIs; and
causing presentation of the set of KPIs in an interface.

2. The system of claim 1, wherein the operations further comprise receiving a user request for the set of KPIs.

3. The system of claim 1, wherein the determining of the set of formulas comprises accessing a KPI formula database.

4. (canceled)

5. The system of claim 1, wherein the LLM removes a non-numeric character from at least one value.

6. The system of claim 5, wherein the LLM determines a KPI by providing the value to a calculator tool and reading an output from the calculator tool.

7. The system of claim 1, wherein the LLM determines the data source and key figure pair for at least one variable name based on semantic similarity.

8. A non-transitory computer-readable medium that stores instructions that, when executed by one or more processors, cause the one or more processors to perform operations comprising:
determining a set of formulas to calculate a set of key performance indicators (KPIs), each formula of the set of formulas comprising a set of variables used in the formula and a mathematical relationship between the set of variables and a corresponding KPI;
generating a first prompt for a large language model (LLM), the first prompt comprising names for the variables used in the set of formulas and, for each of a plurality of data sources, a set of names of key figures in the data source;
receiving, from the LLM and in response to the first prompt, a data source and key figure pair for each variable name in the set of variable names;
accessing, as a value for each of the variables used in the set of formulas, the key figure identified by the LLM from the data source identified by the LLM;
generating a second prompt for the LLM, the second prompt comprising the set of formulas and the values for the variables used in the set of formulas;
receiving, from the LLM and in response to the second prompt, the set of KPIs; and
causing presentation of the set of KPIs in an interface.

9. The non-transitory computer-readable medium of claim 8, wherein the operations further comprise receiving a user request for the set of KPIs.

10. The non-transitory computer-readable medium of claim 8, wherein the determining of the set of formulas comprises accessing a KPI formula database.

11. (canceled)

12. The non-transitory computer-readable medium of claim 8, wherein the LLM removes a non-numeric character from at least one value.

13. The non-transitory computer-readable medium of claim 12, wherein the LLM determines a KPI by providing the value to a calculator tool and reading an output from the calculator tool.

14. The non-transitory computer-readable medium of claim 8, wherein the LLM determines the data source and key figure pair for at least one variable name based on semantic similarity.

15. A method comprising:
determining, by one or more processors, a set of formulas to calculate a set of key performance indicators (KPIs), each formula of the set of formulas comprising a set of variables used in the formula and a mathematical relationship between the set of variables and a corresponding KPI;
generating a first prompt for a large language model (LLM), the first prompt comprising names for the variables used in the set of formulas and, for each of a plurality of data sources, a set of names of key figures in the data source;
receiving, from the LLM and in response to the first prompt, a data source and key figure pair for each variable name in the set of variable names;
accessing, as a value for each of the variables used in the set of formulas, the key figure identified by the LLM from the data source identified by the LLM based on the data source and key figure pairs, values for the set of variables;
generating a second prompt for the LLM, the second prompt comprising the set of formulas and the values for the variables used in the set of formulas;
receiving, from the LLM and in response to the second prompt, the set of KPIs; and
causing presentation of the set of KPIs in an interface.

16. The method of claim 15, further comprising receiving a user request for the set of KPIs.

17. The method of claim 15, wherein the determining of the set of formulas comprises accessing a KPI formula database.

18. (canceled)

19. The method of claim 15, wherein the LLM removes a non-numeric character from at least one value.

20. The method of claim 19, wherein the LLM determines a KPI by providing the value to a calculator tool and reading an output from the calculator tool.

21. The system of claim 1, wherein the operations further comprise receiving, from a user, a selection of the set of data sources.

22. The non-transitory computer-readable medium of claim 8, wherein the operations further comprise receiving, from a user, a selection of the set of data sources.

23. The method of claim 15, further comprising receiving, from a user, a selection of the set of data sources.
